(19) United States
(12) Patent Application Publication
(10) Pub. No.: US 2013/0276537 A1
(43) Pub. Date: Oct. 24, 2013

(54) Micromechanical sensor element and sensor device having this type of sensor element

(71) Applicants: Frank SCHAEFER, Tuebingen (DE); Nicolaus Ulbrich, Gomaringen (DE); Harald Emmerich, Kusterdingen (DE)

(72) Inventors: Frank SCHAEFER, Tuebingen (DE); Nicolaus Ulbrich, Gomaringen (DE); Harald Emmerich, Kusterdingen (DE)

(73) Assignee: Robert Bosch GmbH, Stuttgart (DE)

(21) Appl. No.: 13/869,346

(22) Filed: Apr. 24, 2013

(30) Foreign Application Priority Data
Apr. 24, 2012 (DE) 102012206719.1

(51) Int. Cl. G01C 19/56

(52) U.S. Cl. CPC G01C 19/56
USPC 73/504.12

(57) ABSTRACT

A micromechanical sensor element for detecting lateral acceleration, having at least two boundaries situated essentially orthogonally with respect to one another, and also having at least one spring element, in which the spring element is oriented at an angle relative to at least one of the boundaries.

### RELATED APPLICATION INFORMATION

The present application claims priority to and the benefit of German patent application no. 10 2012 206 719.1, which was filed in Germany on Apr. 24, 2012, the disclosure of which is incorporated herein by reference.

### FIELD OF THE INVENTION

The present invention relates to a micromechanical sensor element. Moreover, the present invention relates to a micromechanical sensor device having a micromechanical sensor element.

### BACKGROUND INFORMATION

In the related art, sensor modules are believed to be understood which have two acceleration channels a_{y}, a_{z} and a yaw rate channel Ωₓ in a housing with a jointly used serial peripheral interface (SPI) for recognizing rollover events of motor vehicles. The acceleration channels are configured for relatively low accelerations, the data of which are prepared with the aid of so-called “low g” acceleration sensors. The mentioned sensor devices for recognizing rollover events are installed in an airbag control unit of the motor vehicle in such a way that one acceleration sensor ascertains acceleration a_{y} transverse to the driving direction, one acceleration sensor ascertains acceleration a_{z} perpendicular to the driving plane of the vehicle, and the yaw rate sensor ascertains the yaw Ωₓ about the vehicle longitudinal axis.

In addition, two-channel acceleration sensors for the airbag sensor system of motor vehicles are believed to be understood. These sensors are configured for high accelerations and are configured as so-called “high g” acceleration sensors. Airbag acceleration sensors are usually installed in the airbag control unit in such a way that one channel measures parallel to the driving direction and one channel measures perpendicularly thereto. The acceleration sensors may be installed skewed by approximately 45 degrees so that both lateral sensor channels respond during a head-on collision or a side collision of the motor vehicle, and the sensor signal may undergo plausibility checking based on a vector resolution. A disadvantage of this type of orientation of the airbag acceleration sensor may be that the yaw rate sensor, which is intended to consistently measure a yaw about a vehicle longitudinal axis, is no longer able to meet its task.

### SUMMARY OF THE INVENTION

An object of the exemplary embodiments and/or exemplary methods of the present invention is to provide a micromechanical sensor element having an expanded field of application.

The object may be achieved by a micromechanical sensor element for detecting lateral acceleration, having at least two boundaries situated essentially orthogonally with respect to one another, and at least one spring element. The sensor element is characterized in that the spring element is oriented at an angle relative to at least one of the boundaries.

In this way, the sensor element according to the present invention in a frequently used x/y, i.e., 0 degree/90 degree, orientation, may be integrated into a sensor device, which in turn is used in the mentioned orientation in a motor vehicle. The sensor element according to the present invention may advantageously be conveniently used for providing acceleration signals for a so-called rollover sensor (ROSE), a sensor for recognizing rollover events of the motor vehicle, and for the airbag sensor system.

One advantageous refinement of the sensor element is characterized in that the spring element has an orientation of approximately 45 degrees relative to the at least one boundary. In the event of a collision of a motor vehicle, it is thus advantageously possible with the aid of a second sensor element to carry out particularly simple plausibility checking of lateral longitudinal and transverse acceleration values.

One specific embodiment of the sensor element is characterized in that the boundaries of the sensor element essentially form a square. This shape contributes to a resource-conserving configuration of the sensor element which, for example, assists in efficient utilization of the available silicon surface area.

A micromechanical sensor device according to the present invention is characterized in that it has at least two micromechanical sensor elements, the sensor device also having a micromechanical Z acceleration sensor element. A sensor device which is usable in a variety of ways is thus provided.

One advantageous refinement of the sensor device is characterized in that the two sensor elements for detecting lateral acceleration are situated skewed by approximately 90 degrees with respect to one another. In this way, plausibility checking of lateral acceleration values may be carried out in a particularly simple manner. Redundancy of lateral acceleration signals, and thus a required safety standard for the sensor device, may thus be easily and cost-effectively provided.

One refinement of the micromechanical sensor device is characterized in that the sensor device has at least two boundaries situated orthogonally with respect to one another, at least one of the boundaries being situated essentially parallel to at least one of the boundaries of at least one of the sensor elements for detecting lateral acceleration. By use of these design measures, a space-saving arrangement of the sensor element according to the present invention in the sensor device is assisted, via which maximum functionality is achievable with the aid of a single sensor module.

The exemplary embodiments and/or exemplary methods of the present invention together with further features and advantages are described in greater detail below with reference to several figures. All described or illustrated features, alone or in any arbitrary combination, constitute the subject matter of the present invention, independently of their recapitulation in the patent claims or their back-reference, and independently of their wording or illustration in the description or in the figures, respectively. The figures are primarily intended to illustrate the principles according to the present invention, and proportions or geometric dimensions may not be inferred therefrom. Functional principles of micromechanical acceleration sensors are known, and therefore are not addressed in greater detail below.

### BRIEF DESCRIPTION OF THE DRAWINGS

FIG. 1 shows one specific embodiment of a micromechanical sensor element according to the present invention.

FIG. 2 shows a micromechanical sensor device having multiple micromechanical sensor elements.

FIG. 3 shows a micromechanical sensor system having a sensor device and a yaw rate sensor.

FIG. 4 shows one example of signal paths for data of micromechanical sensors.

FIG. 5 shows another example of signal paths for data of micromechanical sensors.

### DETAILED DESCRIPTION

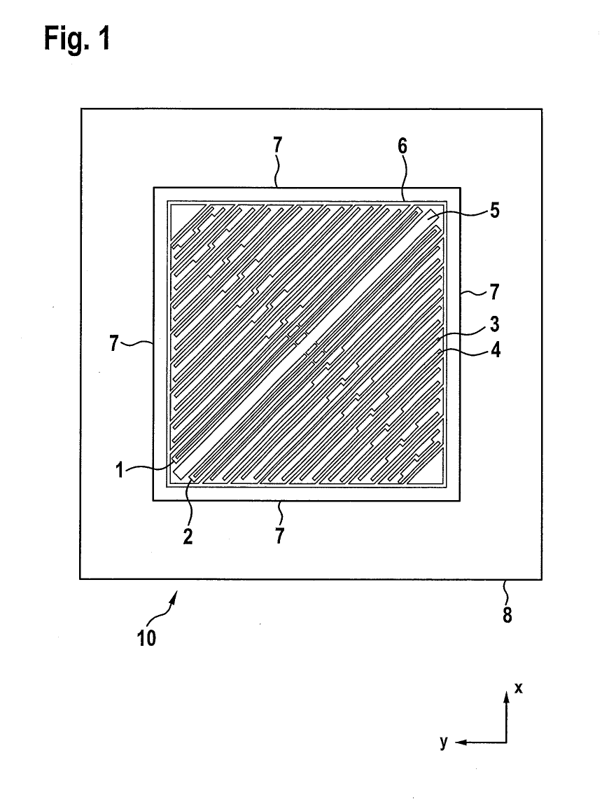

FIG. 1 shows a basic top view of one specific embodiment of a micromechanical sensor element 10 according to the present invention. Sensor element 10 has a first frame 8 made of silicon and a movable second frame 6 made of silicon. First frame 8 essentially defines the surface area necessary to provide an essentially hermetic encapsulation for sensor element 10. Sensor element 10 has, for example, a square circumferential shape with four boundaries 7 situated orthogonally with respect to one another. A first spring element 1 made of silicon and a second spring element 2 made of silicon are movable and deflectable in an x-y plane, and cooperate with a first counter electrode 3 and a second counter electrode 4 in such a way that geometric deflections of spring elements 1, 2 due to the action of force may be detected with the aid of micromechanical principles. Spring elements 1, 2 are anchored to second frame 6 with the aid of an anchor 5. The two counter electrodes 3, 4 illustrated as an example are configured as nonmovable electrodes, and for this purpose have an anchorage down to the substrate, and in each case have an electrical contact.

A geometric orientation of spring elements 1, 2 relative to each of boundaries 7 of sensor element 10 is approximately 45 degrees; of course, any possible angle between spring elements 1, 2 and boundary 7 is conceivable. Due to the angled configuration of spring elements 1, 2, in the illustrated orientation of sensor element 10, lateral accelerations acting on a motor vehicle in the x direction (driving direction) as well as in the y direction (transverse to the driving direction) may be ascertained with the aid of a vector resolution.

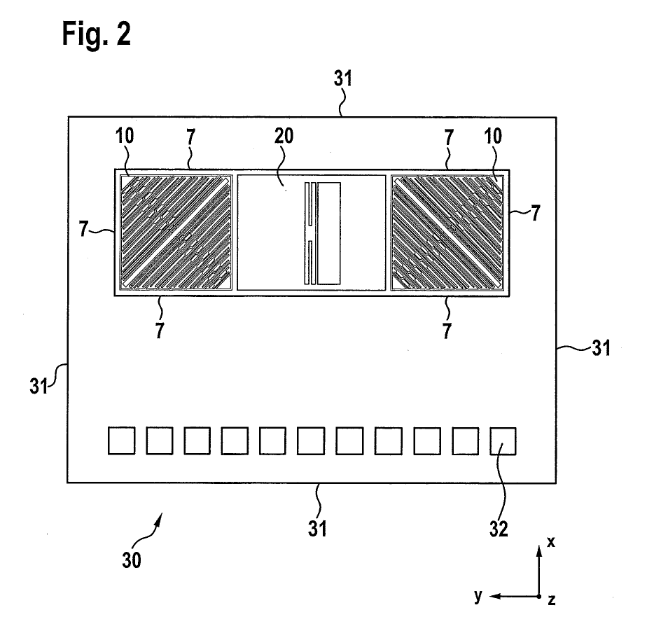

FIG. 2 shows a basic top view of a three-channel micromechanical sensor device 30, having two channels for detecting lateral accelerations and one channel for detecting an acceleration in the z direction. Sensor device 30 has at least two micromechanical sensor elements 10 which are skewed by approximately 90 degrees with respect to one another on sensor device 30. In addition, sensor device 30 has a micromechanical Z acceleration sensor element 20, which due to its rocker-like configuration ascertains an acceleration in the z direction (perpendicular to the driving plane of the motor vehicle). Plausibility checking of signals of the lateral acceleration channels is easily possible with the shown configuration of the two sensor elements 10, thus also supporting a large variety of functions of sensor device 30. It is thus possible to situate sensor device 30 in the illustrated x/y orientation inside the motor vehicle; sensor device 30 may also be used for providing signals for a ROSE sensor with the aid of Z acceleration sensor element 20.

Reference numeral 32 denotes an electrical connection point of sensor device 30 to an integrated electronic evaluation device 50 (not illustrated in FIG. 2), for example for electrically connecting a bond wire or a solder wire. Sensor device 30 is essentially rectangular, with boundaries 7 of sensor elements 10 being oriented inside sensor device 30 essentially corresponding to boundaries 31 of sensor device 30. This advantageously eliminates the need for rotating entire sensor device 30, and the combination of sensor device 30 with a ROSE sensor, which generally requires this type of x/y orientation inside the motor vehicle, is simplified.

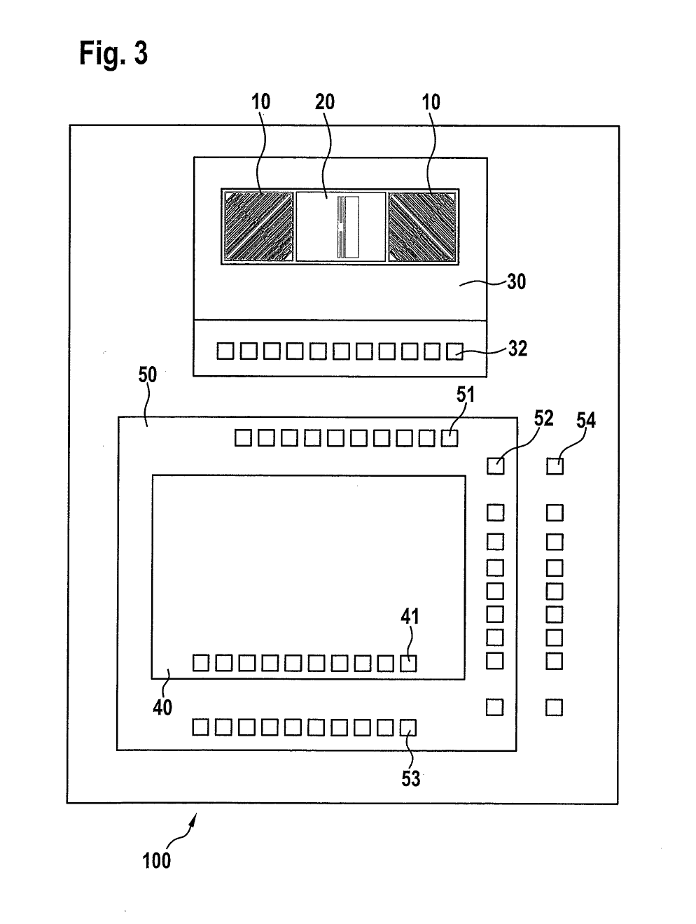

FIG. 3 shows a basic top view of a sensor system 100 having a sensor device 30 and a yaw rate sensor device 40. Yaw rate sensor device 40 is provided for detecting a yaw rate of the motor vehicle, and based on same, in combination with a signal of Z acceleration sensor element 20, to sense a possible rollover event along a longitudinal axis of the motor vehicle. With the aid of a shared electronic evaluation device 50 (an integrated evaluation IC, for example) situated in sensor system 100, signals of sensor device 30 and of yaw rate sensor device 40 are evaluated and further processed.

It is apparent that a three-channel acceleration sensor having two sensor elements 10 according to the present invention and a yaw rate sensor may be combined with one another on sensor system 100 in a resource-conserving manner. This may be achieved by a space-saving, surface area-optimized geometric orientation of yaw rate sensor device 40 and of sensor device 30 within sensor system 100. Acceleration signals for airbags (not illustrated) as well as for the ROSE sensor (including Z acceleration sensor element 20 having yaw rate sensor device 40) may be advantageously detected with the aid of sensor device 30.

With the aid of sensor system 100 in the form of a single housed integrated circuit, the greatest possible degree of functionality is advantageously provided, so that a maximized provision of a micromechanical acceleration sensor system for the motor vehicle is advantageously possible. Reference numerals 51, 52, 53, and 54 denote connection points for electrical contacting, reference numeral 51 representing a connection point for electrically contacting evaluation device 50 with sensor device 30. Reference numeral 52 represents an electrical connection point for electrical contacting between evaluation device 50 and the housing of sensor system 100. Reference numerals 41 and 53 denote connection points for electrical contacting between evaluation device 50 and yaw rate sensor device 40. Reference numeral 54 denotes a connection point for electrical contacting of the housing of sensor system 100.

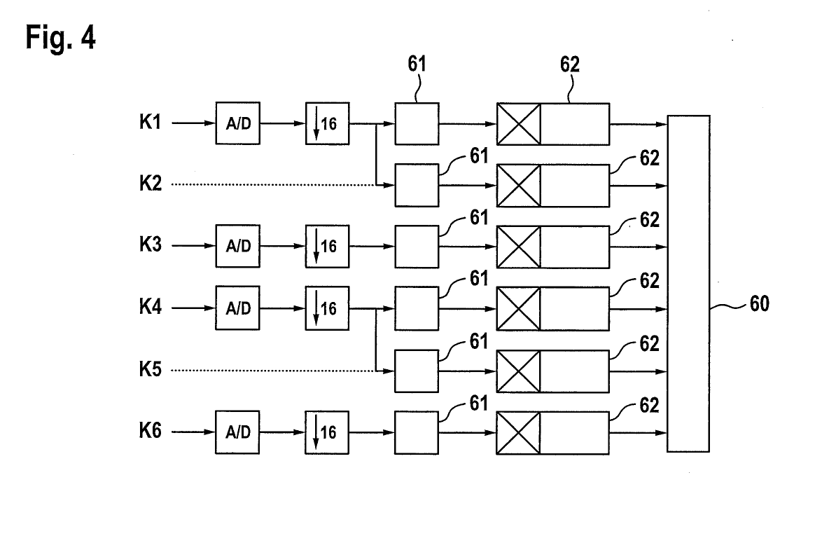

FIG. 4 shows basic signal paths K1 through K6 for data of sensor device 30 and of yaw rate sensor device 40. K1 and K4 denote signal paths for data of sensor device 30 with a bit increment of 10 bits, having an A/D converter, a 16-bit decimation element, a low pass filter 61 (which may be a 400-Hz low pass filter), and an offset controller or offset actuator 62. Offset controller 62 is provided for continuously controlling or calibrating a least significant bit (LSB) of the digital data to zero at a defined control speed. Reference numerals K2, K3, and K5 denote signal paths for data of sensor device 30 and of yaw rate sensor device 40 with a bit increment of 10 bits, having an A/D converter, a low pass filter 61 (which may be a 50-Hz low pass filter), and an offset controller 62. Reference numeral K6 denotes a signal path for data of yaw rate sensor device 40. The data of all signal paths K1 through K6 are output to a data bus 60 which may be configured as a serial peripheral interface (SPI).

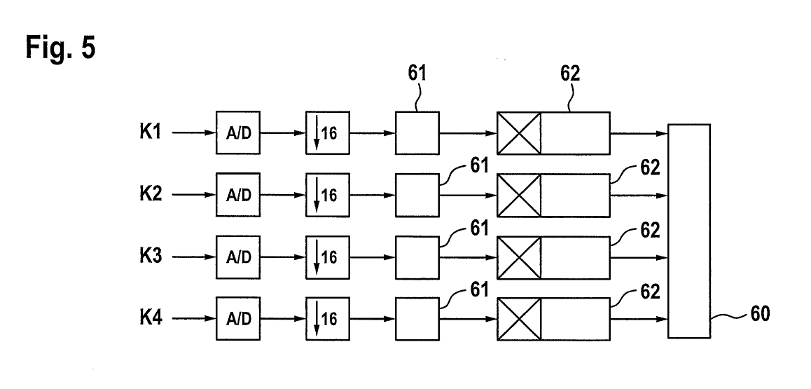

FIG. 5 shows in principle that a reduction in the number of signal paths is advantageously achievable by increasing the bit increment or the signal width of the digital data. Reference numerals K1 and K3 basically denote signal paths for data of sensor device 30 and of yaw rate sensor device 40 with a bit increment of 14 bits, having an A/D converter, a 16-bit decimation element, a low pass filter 61 (which may be a 200-Hz low pass filter), and an offset controller 62. Reference numeral K2 basically denotes a signal path for data of sensor device 30 and data of yaw rate sensor device 40 (acceleration data in the driving plane and perpendicular to the driving plane) with a bit increment of 10 bits, having an A/D converter, a low pass filter 61 (which may be a 50-Hz low pass filter), and an offset controller 62. Reference numeral K6 basically denotes a signal path for data of yaw rate sensor device 40.

The same as in the configuration in FIG. 4, the data of all signal paths K1 through K4 are output to a data bus 60 which may be configured as an SPI. It is also apparent that the number of signal paths may advantageously be reduced from six to four with the aid of an increased bit increment (14 bits compared to 10 bits) of the acceleration data.

In summary, the exemplary embodiments and/or exemplary methods of the present invention provides for an improved configuration for a micromechanical sensor element which is very well suited for use in a combination module for an offset-controlled ROSE detection and for ascertaining lateral acceleration data in the driving direction and transverse to the driving direction. Due to the specific +45 degree or −45 degree orientations of spring elements 1, 2 of the two sensor elements 10 of sensor device 30, collision events may be detected in a simplified manner using two lateral channels for acceleration instead of the conventional self-plausibility checking of acceleration data of a sensor module housing oriented 45 degrees with respect to the driving direction.

In addition, with the aid of the two sensor elements 10 according to the present invention in sensor device 30 and Z acceleration sensor element 20, the use with two acceleration lateral channels parallel and transverse as well as perpendicular to the driving direction may be achieved in a shared module housing. In this way the exemplary embodiments and/or exemplary methods of the present invention may be used particularly advantageously in a combination sensor which in a single housing provides a ROSE sensor functionality together with an airbag acceleration sensor functionality. Sensor device 30 is thus advantageously usable universally without having to modify installation orientation specifications in an airbag control unit. Significant cost savings for a motor vehicle sensor system may advantageously result due to volume effects.

Those skilled in the art will be able to suitably modify the features of the exemplary embodiments and/or exemplary methods of the present invention and combine them with one another without departing from the core of the present invention.

What is claimed is:

1. A micromechanical sensor element for detecting a lateral acceleration, comprising:
at least two boundaries situated essentially orthogonally with respect to one another; and
at least one spring element, wherein the spring element is oriented at an angle relative to at least one of the boundaries.

2. The micromechanical sensor element of claim 1, wherein the spring element has an orientation of approximately 45 degrees relative to the at least one of the boundaries.

3. The micromechanical sensor element of claim 1, wherein the at least two boundaries include four boundaries that essentially form a square.

4. A micromechanical sensor device, comprising:
at least two micromechanical sensor elements, each of the micromechanical sensor elements being for detecting a lateral acceleration, and including at least two boundaries situated essentially orthogonally with respect to one another, and including at least one spring element, wherein the spring element is oriented at an angle relative to at least one of the boundaries; and
a micromechanical Z acceleration sensor element.

5. The micromechanical sensor device of claim 4, wherein the two sensor elements for detecting lateral acceleration are situated skewed by approximately 90 degrees with respect to one another.

6. The micromechanical sensor device of claim 5, wherein the sensor device has at least two boundaries situated orthogonally with respect to one another, at least one of the boundaries being situated essentially parallel to at least one of the boundaries of at least one of the sensor elements for detecting lateral acceleration.

7. A sensor system, comprising:
a micromechanical sensor device, including:
at least two micromechanical sensor elements, each of the micromechanical sensor elements being for detecting a lateral acceleration, and including at least two boundaries situated essentially orthogonally with respect to one another, and including at least one spring element, wherein the spring element is oriented at an angle relative to at least one of the boundaries; and
a micromechanical Z acceleration sensor element;
a yaw rate sensor device; and
a shared evaluation device for evaluating data of the sensor device and of the yaw rate sensor device.

8. The sensor system of claim 7, wherein the data of the sensor device and of the yaw rate sensor device are transmitted via a digital serial data bus.

9. The sensor system of claim 8, wherein the data of the sensor device and of the yaw rate sensor device each have a bit increment of at least 14 bits.
